(19) United States
(12) Patent Application Publication
(10) Pub. No.: US 2015/0134256 A1
(43) Pub. Date: May 14, 2015

(54) LATE TIME ROTATION PROCESSING OF MULTI-COMPONENT TRANSIENT EM DATA FOR FORMATION DIP AND AZIMUTH

(71) Applicants: Marina N. Nikitenko, Novosibirsk (RU); Michael Boris Rabinovich, Houston, TX (US); Mikhail V. Sviridov, Novosibirsk (RU)

(72) Inventors: Marina N. Nikitenko, Novosibirsk (RU); Michael Boris Rabinovich, Houston, TX (US); Mikhail V. Sviridov, Novosibirsk (RU)

(73) Assignee: BAKER HUGHES INCORPORATED, Houston, TX (US)

(21) Appl. No.: 14/539,014

(22) Filed: Nov. 12, 2014

(30) Foreign Application Priority Data
Nov. 11, 2013 (RU) PCT/RU2013/001004

(51) Int. Cl. G01V 3/38; G01V 3/12

(52) U.S. Cl. CPC G01V 3/38; G01V 3/12
USPC 702/7

(57) ABSTRACT

A system and method to determine a dip angle and an azimuth angle of a formation are described. The system includes a transmitter disposed in a borehole to change a transmitted current to induce a current in an earth formation, and a receiver disposed in the borehole, spaced apart from the transmitter, to receive transient electromagnetic signals. The system also includes a processor to extract multi-time focusing (MTF) responses from the transient electromagnetic signals, determine a relative dip angle and a rotation of a tool comprising the transmitter and receiver based on the MTF responses, and estimate the dip angle and the azimuth angle of the formation based on the relative dip angle and the rotation of the tool.

### CROSS-REFERENCE TO RELATED APPLICATION

This application claims the benefit of priority to PCT Application No. PCT/RU2013/001004 filed Nov. 11, 2013, the disclosure of which is incorporated herein by reference in its entirety.

### BACKGROUND

In exploration and production efforts, of downhole formations, for example, a number of sensors and measurement systems are used to obtain information that may be used to make a variety of decisions. Among the information may be formation dip and azimuth information. Such information may be used for geosteering, to derive bed direction, or as an initial guess in the resolution of parameters such as distance to bed and formation resistivities.

### SUMMARY

According to an embodiment of the invention, a system to determine a dip angle and an azimuth angle of a formation includes a transmitter disposed in a borehole, the transmitter configured to change a transmitted current to induce a current in an earth formation; a receiver disposed in the borehole, spaced apart from the transmitter and configured to receive transient electromagnetic signals; and a processor configured to extract multi-time focusing (MTF) responses from the transient electromagnetic signals, determine a relative dip angle and a rotation of a tool comprising the transmitter and receiver based on the MTF responses, and estimate the dip angle and the azimuth angle of the formation based on the relative dip angle and the rotation of the tool.

According to another embodiment of the invention, a method of determining a dip angle and an azimuth angle of a formation includes disposing a transmitter in a borehole; the transmitter changing a transmitted current to induce a current in an earth formation; disposing a receiver in the borehole spaced apart from the transmitter; the receiver receiving transient electromagnetic signals; processing the transient electromagnetic signals to extract multi-time focusing (MTF) responses; determining a relative dip angle and a rotation of a tool comprising the transmitter and the receiver based on the multi-time focusing responses; and estimating the dip angle and the azimuth angle of the formation based on the relative dip angle and the rotation of the tool.

### BRIEF DESCRIPTION OF THE DRAWINGS

Referring now to the drawings wherein like elements are numbered alike in the several Figures:

FIG. 1 is a cross-sectional view of a system to determine dip and azimuth according to an embodiment of the invention;

FIG. 2 is a block diagram of the system for obtaining electromagnetic information according to an embodiment of the invention; and

FIG. 3 is a process flow of a method of determining formation dip and azimuth according to an embodiment of the invention.

### DETAILED DESCRIPTION

As noted above, formation dip and azimuth may be among the parameters obtained during exploration and production efforts. Embodiments of the system and method described herein relate to a multi-time focusing technique using transient electromagnetic signals recorded in the formation to estimate the formation dip and azimuth.

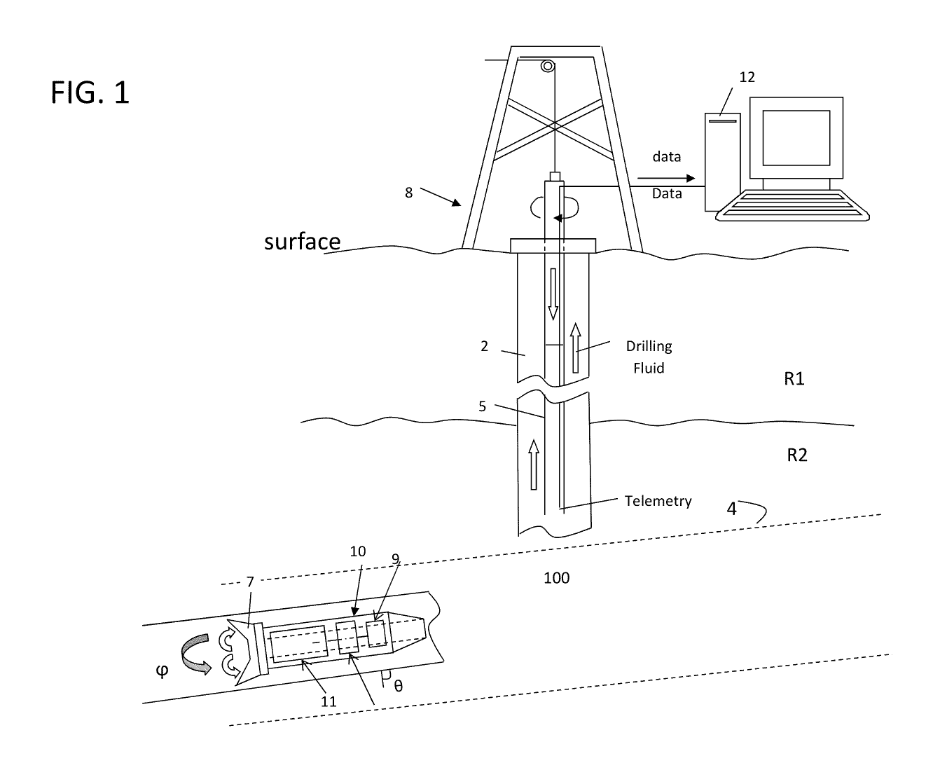

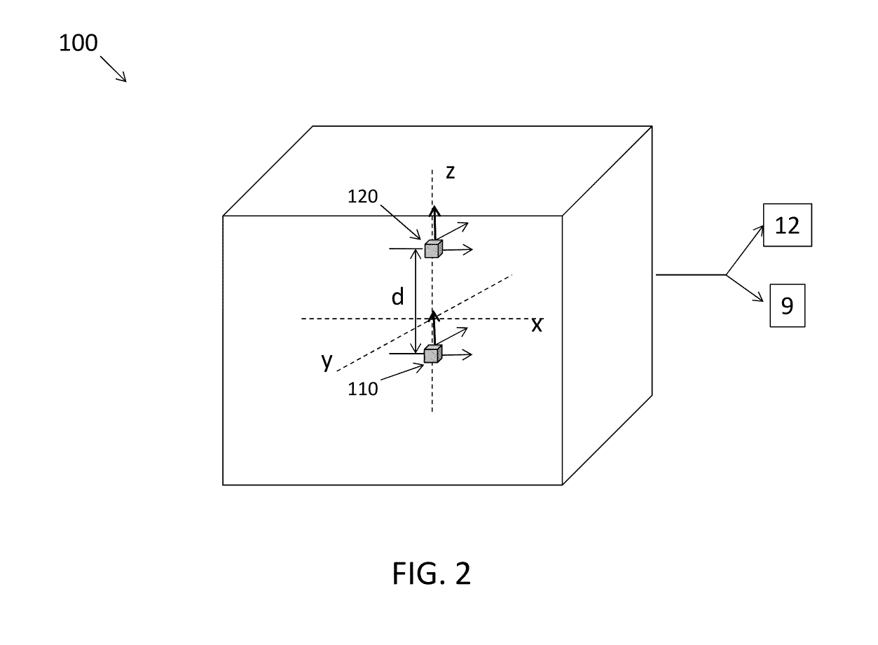

FIG. 1 is a cross-sectional view of a system to determine dip and azimuth according to an embodiment of the invention. While the system may operate in any subsurface environment, FIG. 1 shows a downhole tool 10 disposed in a borehole 2 penetrating the earth 3. The downhole tool 10 is disposed in the borehole 2 at a distal end of a carrier 5. The downhole tool 10 may include measurement tools 11 and downhole electronics 9 configured to perform one or more types of measurements in an embodiment known as Logging-While-Drilling (LWD) or Measurement-While-Drilling (MWD). According to the LWD/MWD embodiment, the carrier 5 is a drill string. The measurements may include measurements related to drill string operation, for example. A drilling rig 8 is configured to conduct drilling operations such as rotating the drill string and, thus, the drill bit 7. The drilling rig 8 also pumps drilling fluid through the drill string in order to lubricate the drill bit 7 and flush cuttings from the borehole 2. Raw data and/or information processed by the downhole electronics 9 may be telemetered to the surface for additional processing or display by a computing system 12. Drilling control signals may be generated by the computing system 12 and conveyed downhole or may be generated within the downhole electronics 9 or by a combination of the two according to embodiments of the invention. The downhole electronics 9 and the computing system 12 may each include one or more processors and one or more memory devices. In alternate embodiments, the carrier 5 may be an armored wireline used in wireline logging. As shown in FIG. 1, the borehole 2 penetrates two layers with different resistivities (R1 and R2). Among the downhole tools 10 is a tool to measure borehole deviation and azimuth during drilling. The borehole 2 may be vertical in some portions. As shown in FIG. 1, a portion of the borehole 2 is formed non-vertically within a formation 4 of interest with a downhole tool 10 relative dip angle θ (angle between formation 4 normal and the downhole tool 10 axis) and a rotation angle φ. As detailed below, these angles are used to estimate the formation dip and azimuth. The downhole tool 10 according to embodiments of the invention also includes a system 100 for obtaining electromagnetic information used to determine the relative dip angle θ and rotation angle φ and, subsequently, the formation dip and azimuth. The system 100 is detailed in FIG. 2.

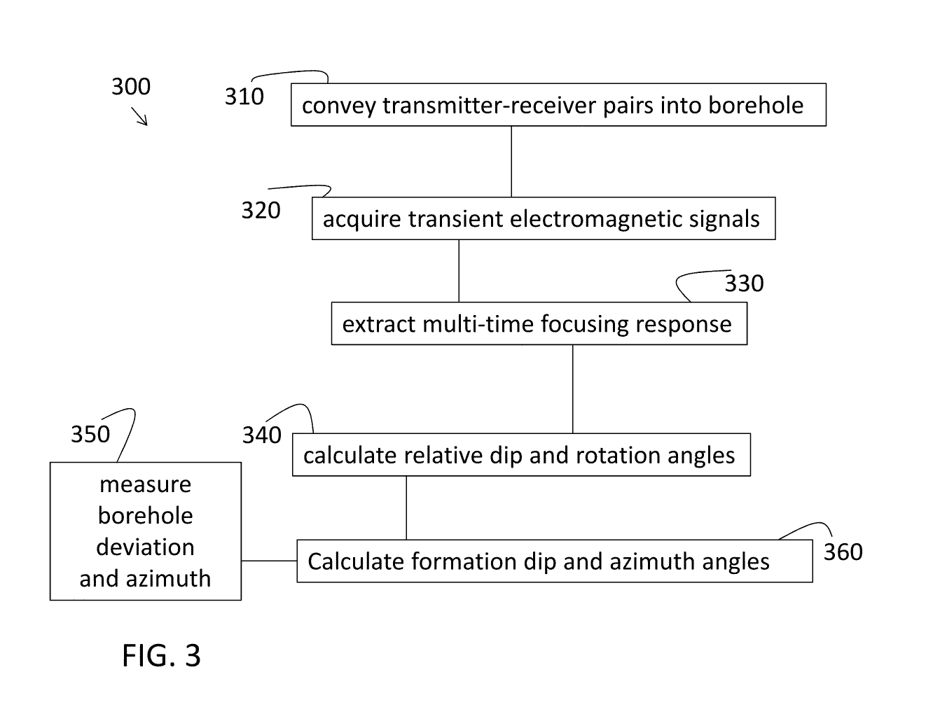

FIG. 2 is a block diagram of the system 100 for obtaining electromagnetic information according to an embodiment of the invention. The system 100 includes an axial transmitter 110 and receiver 120 where the transmitter 110 and receiver 120 are spaced apart from each other by some predetermined distance d. The output from the system 100 may be provided to the downhole electronics 9, the computing system 12, or some combination thereof to perform the method of processing the received transient electromagnetic signals as described below. As shown in FIG. 2, the transmitter 110 and receiver 120 may provide measurements of at least four voltage components: XX, XY, ZZ, XZ (or ZX). That is, voltage may be obtained based on the receiver 120-receiving transient electromagnetic (TEM) signals generated by the transmitter. The transmitter may induce current in mutually orthogonal directions. For some specified time interval, the transmitter 110 coil may be turned on and off to induce a current in the surrounding formation 4. The receiver 120 then receives the resulting transient electromagnetic pulses that form the electromagnetic information. The processing of the received electromagnetic information to determine dip and azimuth of the formation 4 is detailed with regard to FIG. 3.

FIG. 3 is a process flow of a method 300 of determining formation dip and azimuth according to an embodiment of the invention. At block 310, conveying the transmitter 110 and receiver 120 into the borehole 2 is as shown in FIG. 1, for example. Acquiring transient electromagnetic signals, at block 320, includes turning the transmitter 110 coil on and off. The transient electromagnetic signals may include four voltage components: XX, YY, ZZ, and XZ (or ZX). Extracting a multi-time focusing response at block 330 involves several steps. The multi-time focusing (MTF) response S_{5/2} is the coefficient in the term proportional to time t^{5/2}. That is, this is the term of interest to extract. Using the received transient electromagnetic signals, voltage may be expanded into the following series at the late times (later portion of the receiving time window):

V=S_{5/2}·t^{-5/2}+S_{7/2}·t^{-7/2}+S_{9/2}·t^{-9/2}+S_{11/2}·t^{-11/2}+ [EQ. 1]

Voltage measurements \vec{V} at several late times may be used to calculate expansion coefficients {tilde over (\vec{S} from the following linear system:

$$[ \begin{matrix}{V}_{1} \\ {V}_{2} \\ {V}_{3} \\ {V}_{4} \\ … \\ {V}_{m - 1} \\ {V}_{m}\end{matrix} ] = [ \begin{matrix}{t}_{1}^{- 5 / 2} & {t}_{1}^{- 7 / 2} & {t}_{1}^{- 9 / 2} & … & {t}_{1}^{- n / 2} \\ {t}_{2}^{- 5 / 2} & {t}_{2}^{- 7 / 2} & {t}_{2}^{- 9 / 2} & … & {t}_{2}^{- 5 / 2} \\ {t}_{3}^{- 5 / 2} & {t}_{3}^{- 7 / 2} & {t}_{3}^{- 9 / 2} & … & {t}_{3}^{- n / 2} \\ {t}_{4}^{- 5 / 2} & {t}_{4}^{- 7 / 2} & {t}_{4}^{- 9 / 2} & … & {t}_{4}^{- n / 2} \\ … & … & … & … & … \\ {t}_{m - 1}^{- 5 / 2} & {t}_{m - 1}^{- 7 / 2} & {t}_{m - 1}^{- 9 / 2} & … & {t}_{m - 1}^{- n / 2} \\ {t}_{m}^{- 5 / 2} & {t}_{m}^{- 7 / 2} & {t}_{m}^{- 9 / 2} & … & {t}_{m}^{- 5 / 2}\end{matrix} ] \cdot [ \begin{matrix}{S}_{5 / 2} \\ {S}_{7 / 2} \\ {S}_{9 / 2} \\ … \\ {S}_{n / 2}\end{matrix} ] \qquad [ EQ . 2 ]$$

In matrix form, EQ. 2 may be written as:

\vec{V}={tilde over (\hat{T}·{tilde over (\vec{S} [EQ. 3]

where n=7, 9, 11, . . . . The length of {tilde over (\vec{S} is l=(n−3)/2; m≧l.

To improve the condition number of matrix {tilde over (\hat{T}, EQ. 3 may be multiplied by the normalization matrix \hat{N}:

$$\hat{N} = [ \begin{matrix}{t}_{1}^{5 / 2} & 0 & 0 & … & 0 \\ 0 & {t}_{1}^{/ 2} & 0 & … & 0 \\ 0 & 0 & {t}_{1}^{9 / 2} & … & 0 \\ … & … & … & … & … \\ 0 & 0 & 0 & … & {t}_{1}^{n / 2}\end{matrix} ] \qquad [ EQ . 4 ]$$

to yield:

\vec{V}={hacek over (\hat{T}·{hacek over (\vec{S}[EQ.5]

If the times grow geometrically (exponentially in the discrete time domain), then {hacek over (\hat{T} may be obtained:

$$\hat{\tilde{T}} = \hat{\tilde{T}} \cdot \hat{N} = [ \begin{matrix}1 & 1 & 1 & … & 1 \\ {p}^{- 5 / 2} & {p}^{- 7 / 2} & {p}^{- 9 / 2} & … & {p}^{- n / 2} \\ {( {p}^{2} )}^{- 5 / 2} & {( {p}^{2} )}^{- 7 / 2} & {( {p}^{2} )}^{- 9 / 2} & … & {( {p}^{2} )}^{- n / 2} \\ {( {p}^{3} )}^{- 5 / 2} & {( {p}^{3} )}^{- 7 / 2} & {( {p}^{3} )}^{- 9 / 2} & … & {( {p}^{3} )}^{- n / 2} \\ … & … & … & … & … \\ {( {p}^{m - 2} )}^{- 5 / 2} & {( {p}^{m - 2} )}^{7 / 2} & {( {p}^{m - 2} )}^{- 9 / 2} & … & {( {p}^{m - 2} )}^{- n / 2} \\ {( {p}^{m - 1} )}^{- 5 / 2} & {( {p}^{m - 1} )}^{- 7 / 2} & {( {p}^{m - 1} )}^{- 9 / 2} & … & {( {p}^{m - 1} )}^{- n / 2}\end{matrix} ] \\ where p = {t}_{1} \text{/} {t}_{i - 1} . \qquad [ EQ . 6 ]$$

Using EQ. 6 in EQ. 5, and substituting EQ. 3 yields:

$$\vec{\breve{S}} = {\hat{N}}^{- 1} \cdot \vec{\tilde{S}} = [ \begin{matrix}{S}_{5 / 2} \cdot {t}^{- 5 / 2} \\ {S}_{7 / 2} \cdot {t}^{- 7 / 2} \\ {S}_{9 / 2} \cdot {t}^{- 9 / 2} \\ … \\ {S}_{n / 2} \cdot {t}^{- n / 2}\end{matrix} ] \qquad [ EQ . 7 ]$$

The system of EQ. 5 may be solved by the singular value decomposition (SVD) method, which provides a solution with the minimal norm. As a result, the MTF response may be obtained as:

S_{5/2}=\tilde{S}₁=\check{S}₁·t₁^{5/2} [EQ. 8]

At block 340 of the method 300 shown in FIG. 3, calculating the relative dip (θ) and rotation (φ) angles is done as described below. For convenience, S_{5/2} is denoted as R. Then, the measured MTF components are expressed as:

$$[ \begin{matrix}{R}_{xx} \\ {R}_{xy} \\ {R}_{xz} \\ {R}_{yx} \\ {R}_{yy} \\ {R}_{yz} \\ {R}_{zx} \\ {R}_{zy} \\ {R}_{zz}\end{matrix} ] = [ \begin{matrix}{cos}^{2} ϕ \cdot {cos}^{2} θ + {sin}^{2} ϕ & {cos}^{2} ϕ \cdot {sin}^{2} θ \\ cos ϕ \cdot sin ϕ \cdot {sin}^{2} θ & - cos ϕ \cdot sin ϕ \cdot {sin}^{2} θ \\ cos ϕ \cdot cos θ \cdot sin θ & - cos ϕ \cdot cos θ \cdot sin θ \\ cos ϕ \cdot sin ϕ \cdot {sin}^{2} θ & - cos ϕ \cdot sin ϕ \cdot {sin}^{2} θ \\ {sin}^{2} ϕ \cdot {cos}^{2} θ + {cos}^{2} ϕ & {sin}^{2} ϕ \cdot {sin}^{2} θ \\ - sin ϕ \cdot cos θ \cdot sin θ & sin ϕ \cdot cos θ \cdot sin θ \\ cos ϕ \cdot cos θ \cdot sin θ & - cos ϕ \cdot cos θ \cdot sin θ \\ - sin ϕ \cdot cos θ \cdot sin θ & sin ϕ \cdot cos θ \cdot sin θ \\ {sin}^{2} θ & {cos}^{2} θ\end{matrix} ] \cdot [ \begin{matrix}{R}_{xx}^{p} \\ {R}_{zz}^{p}\end{matrix} ] \qquad [ EQ . 9 ]$$

where Rₓₓ^{p}, R_{zz}^{p} are principal components, θ is the relative dip angle (between the formation 4 normal and the downhole tool 10 axis), and φ is the rotation angle. Pairs of components R_{xy} and R_{yx}, R_{xz} and R_{zx}, R_{yz} and R_{zy} have the same representation via the principle components. The components R_{xy} and R_{yx} coincide by definition, but they may differ in practice. That is, real MTF responses may not coincide due to inaccuracies in the calculation of the responses (lack of late time responses) and the presence of measurement noise. Consequently, to achieve a stable solution to EQ. 9, appropriate measured components must be chosen.

At block 350 of the method 300 shown in FIG. 3, measuring borehole 2 deviation and azimuth is done during drilling. At block 360, calculating the formation dip and azimuth angles includes using the borehole 2 deviation and azimuth and the relative dip (θ) and rotation (φ) angles.

Non-limiting examples illustrating embodiments of the method and system discussed above are detailed below. For example, an exemplary transmitter 110 is spaced 5 meters (m) apart from the exemplary receiver 120. The coil moment when the current impulse is turned off is 1 square meters (m²). The exemplary receiver 120 coil measures the electromagnetic field (emf) and all 9 components (XX, XY, XZ, YX, YY, YZ, ZX, ZY, ZZ) using three transmitter-receiver pairs 110 are obtained. For 16 times between 0.35 milliseconds (ms) to 0.5 ms, with a relative dip (θ) angle of 36 degrees and rotation (φ) angle of 54 degrees, the MTF responses for 2, 3, 4, and 5 terms used in the expansion are as shown in Table 1. The MTF responses are in millivolts-micro seconds.

TABLE 1
MTF responses (mV · μs^{5/2}) for different
number of terms used in expansion.

| Number | | | | | | | | | |
|---|---|---|---|---|---|---|---|---|---|
| of | Component | | | | | | | | |
| terms | XX | XY | XZ | YX | YY | YZ | ZX | ZY | ZZ |
| 2 | −11.1 | 1.44 | 2.69 | 1.44 | −12.0 | −3.71 | 2.15 | −2.96 | −15.7 |
| 3 | −11.9 | 1.57 | 2.88 | 1.57 | −13.0 | −3.96 | 2.44 | −3.36 | −17.0 |
| 4 | −12.6 | 1.63 | 2.94 | 1.63 | −13.5 | −4.05 | 2.57 | −3.54 | −17.8 |
| 5 | −12.8 | 1.58 | 2.96 | 1.58 | −13.3 | −3.96 | 2.62 | −3.55 | −17.6 |

While Table 1 illustrates some stability in the MTF responses over the different number of terms, the responses cannot be calculated to a predefined accuracy. In addition, the components R_{xz} and R_{zx} and the components R_{yz} and R_{zy} do not coincide. Thus, the number of terms must be chosen based on numerous test calculations of the dip and rotations for the specified time interval. In this regard, the condition number of the matrix {tilde over (\hat{T} is shown in Table 2.

TABLE 2
Condition number of the expansion matrix.

| Number of terms | Condition number |
|---|---|
| 2 | 21 |
| 3 | 490 |
| 4 | 11760 |
| 5 | 287540 |

As Table 2 indicates, the condition number (change in output based on small change in input parameter) increases as the number of terms increases. It bears noting that the number of times (m, see e.g., EQ. 2) and the time geometric increment also influence condition number. These parameters are chosen to minimize condition number. As Table 2 indicates, condition number is too large for the case of 5 terms, and errors in the field data may considerably effect the result.

Table 3 indicates the terms S_{j/2}·t^{-j/2}, for j=5, 7, 9, 11, and 13 for Rₓₓ response for different terms in the expansion.

TABLE 3
Expansion terms (nV) for XX component for different number
of terms used in expansion, t = 0.35 ms.

| | Term | | | | |
|---|---|---|---|---|---|
| No. of terms | S_{5/2} · t^{-5/2} | S_{j/2} · t^{-7/2} | S_{j/2} · t^{-9/2} | S_{j/2} · t^{-11/2} | s_{j/2} · t^{-13/2} |
| 2 | −4.73 | 0.893 | | | |
| 3 | −5.09 | 1.73 | −0.479 | | |
| 4 | −5.35 | 2.63 | −1.53 | 0.405 | |
| 5 | −5.47 | 3.22 | −2.57 | 1.22 | −0.235 |

As Table 3 illustrates, after the first MTF response, there is no regularity in the behavior among the terms. Thus, only the first term of the series may be extracted to a predetermined accuracy. While the other terms cannot be determined, they influence MTF response calculation.

The following exemplary tables (Tables 4-6) show results of angle evaluation in cases with different sets of available components. Discretization of 0.5 degrees is used. For each pair of relative dip and rotation angles, {θ,φp}={i/2, j/2}, i,j=1, . . . , 180, the linear system of EQ. 6 is solved by a singular value decomposition (SVD) method. The solution corresponding to the minimal misfit has been chosen, and the case of relative dip (θ)=0 degree was not considered for average absolute error calculation.

TABLE 4
Estimates of the angles (degree) using all 9 components.

| | | | | | | |
|---|---|---|---|---|---|---|
| φ | 0 | 18 | 36 | 54 | 72 | 90 |
| θ | | | | | | |

| | |
|---|---|
| | Arbitrary |
| 0 | 0 |

| | | | | | | |
|---|---|---|---|---|---|---|
| | 3 | 18 | 36 | 54 | 72 | 87 |
| 18 | 18 | 18 | 18 | 18 | 18 | 18 |
| | 5 | 18 | 36 | 54 | 72 | 85 |
| 36 | 36 | 36 | 36 | 36 | 36 | 36 |
| | 5 | 17.5 | 35.5 | 54.5 | 72.5 | 85 |
| 54 | 54.5 | 54.5 | 54.5 | 54.5 | 54.5 | 54.5 |
| | 5 | 18 | 36 | 54 | 72 | 85 |
| 72 | 73 | 73.5 | 73.5 | 73.5 | 73.5 | 73 |
| | 0.5 | 18 | 6 | 54 | 72 | 89.5 |
| 90 | 90 | 90 | 90 | 90 | 90 | 90 |

Table 4, above, shows estimates of the relative dip and rotation angles (θ, φ) using all 9 components. The average absolute error in the relative dip angle (θ) estimate is 0.4 degrees, and the average absolute error in the rotation angle (φ) estimate is 1.3 degrees.

TABLE 5
Estimates of the angles (degree) using 5 components.

| | | | | | | |
|---|---|---|---|---|---|---|
| φ | 0 | 18 | 3 | 54 | 72 | 90 |
| θ | | | | | | |

| | |
|---|---|
| | Arbitrary |
| 0 | 0 |

| | | | | | | |
|---|---|---|---|---|---|---|
| | 4 | 19 | 36.5 | 55.5 | 71.5 | 90 |
| 18 | 18 | 18 | 18 | 18.5 | 17.5 | 18 |
| | 0 | 17 | 37 | 53 | 72.5 | 90 |
| 36 | 35.5 | 35.5 | 36 | 35.5 | 36.5 | 36 |
| | 0 | 14 | 34.5 | 55 | 72.5 | 85 |
| 54 | 55 | 54 | 54 | 54 | 54 | 54 |
| | 5.5 | 16 | 36 | 54.5 | 72.5 | 88.5 |
| 72 | 73.5 | 73 | 73.5 | 73 | 72.5 | 72.5 |
| | 2 | 18 | 34.5 | 54 | 72 | 87.5 |
| 90 | 90 | 90 | 90 | 90 | 90 | 88.5 |

Table 5, above, shows estimates of the relative dip and rotation angles (θ, φ) using 5 components (XX, YY, ZZ, XZ, ZX). The average absolute error in the relative dip angle (θ) estimate is 0.4 degrees, and the average absolute error in the rotation angle (φ) estimate is 1.1 degrees. As a comparison with Table 4 indicates, the average absolute error values resulting in Table 5 using 5 components are similar to those obtained in Table 4 using 9 components.

TABLE 6
Estimates of the angles (degree) using 4 components.

| | | | | | | |
|---|---|---|---|---|---|---|
| φ | 0 | 18 | 36 | 54 | 72 | 90 |
| θ | | | | | | |

| | |
|---|---|
| | Arbitrary |
| 0 | 0 |

| | | | | | | |
|---|---|---|---|---|---|---|
| | 15.5 | 24 | 36.5 | 53 | 71.5 | 90 |
| 18 | 19.5 | 19.5 | 19 | 18.5 | 18.5 | 18 |
| | 17 | 23.5 | 38 | 52.5 | 71 | 90 |
| 36 | 38 | 37.5 | 37.5 | 36.5 | 36 | 36 |
| | 13.5 | 21.5 | 37 | 53.5 | 71 | 90 |
| 54 | 54 | 54 | 54 | 54 | 54 | 54 |
| | 10.5 | 20 | 37 | 53.5 | 70.5 | 88.5 |
| 72 | 70 | 70 | 70 | 70 | 71.5 | 72.5 |
| | 10 | 20.5 | 37 | 53.5 | 73.5 | 85.5 |
| 90 | 87 | 87 | 87 | 87 | 86.5 | 86 |

Table 6, above, shows estimates of the relative dip and rotation angles (θ, φ) using 4 components (XX, YY, ZZ, XZ). The average absolute error in the relative dip angle (θ) estimate is 1.3 degrees, and the average absolute error in the rotation angle (φ) estimate is 3.6 degrees. A comparison with the average absolute error values associated with Tables 4 and 5 indicates that using the 4 components resulting in the estimates in Table 6 provides the worst estimates among the three exemplary cases.

While one or more embodiments have been shown and described, modifications and substitutions may be made thereto without departing from the spirit and scope of the invention. Accordingly, it is to be understood that the present invention has been described by way of illustrations and not limitation.

1. A system to determine a dip angle and an azimuth angle of a formation, the system comprising:
a transmitter disposed in a borehole, the transmitter configured to change a transmitted current to induce a current in an earth formation;
a receiver disposed in the borehole, spaced apart from the transmitter and configured to receive transient electromagnetic signals; and
a processor configured to extract multi-time focusing (MTF) responses from the transient electromagnetic signals, determine a relative dip angle and a rotation of a tool comprising the transmitter and receiver based on the MTF responses, and estimate the dip angle and the azimuth angle of the formation based on the relative dip angle and the rotation of the tool.

2. The system according to claim 1, wherein the transmitter is a tri-axial transmitter, and the receiver is a tri-axial receiver.

3. The system according to claim 2, wherein three axes of the tri-axial transmitter may be mutually orthogonal.

4. The system according to claim 3, wherein, the processor processes at least four components of the transient electromagnetic signals, the at least four components including: XX, YY, ZZ, and ZX or XZ.

5. The system according to claim 1, wherein the processor extracts the MTF responses (S) based on expanding voltage (V) into a series at the late times (t) which are later portions of a receiving time window for the transient electromagnetic signals:
V=S_{5/2}·t^{-5/2}+S_{7/2}·t^{-7/2}+S_{9/2}·t^{-9/2}+S_{11/2}·t^{-11/2}+ . . . .

6. The system according to claim 5, wherein the processor uses voltage measurements, \vec{V}, for several known late times to compute expansion coefficient {tilde over (\vec{S} corresponding with the MTF responses according to a linear system:
$$[ \begin{matrix}{V}_{1} \\ {V}_{2} \\ {V}_{3} \\ {V}_{4} \\ … \\ {V}_{m - 1} \\ {V}_{m}\end{matrix} ] = [ \begin{matrix}{t}_{1}^{- 5 / 2} & {t}_{1}^{- 7 / 2} & {t}_{1}^{- 9 / 2} & … & {t}_{1}^{- n / 2} \\ {t}_{2}^{- 5 / 2} & {t}_{2}^{- 7 / 2} & {t}_{2}^{- 9 / 2} & … & {t}_{2}^{- 5 / 2} \\ {t}_{3}^{- 5 / 2} & {t}_{3}^{- 7 / 2} & {t}_{3}^{- 9 / 2} & … & {t}_{3}^{- n / 2} \\ {t}_{4}^{- 5 / 2} & {t}_{4}^{- 7 / 2} & {t}_{4}^{- 9 / 2} & … & {t}_{4}^{- n / 2} \\ … & … & … & … & … \\ {t}_{m - 1}^{- 5 / 2} & {t}_{m - 1}^{- 7 / 2} & {t}_{m - 1}^{- 9 / 2} & … & {t}_{m - 1}^{- n / 2} \\ {t}_{m}^{- 5 / 2} & {t}_{m}^{- 7 / 2} & {t}_{m}^{- 9 / 2} & … & {t}_{m}^{- 5 / 2}\end{matrix} ] \cdot [ \begin{matrix}{S}_{5 / 2} \\ {S}_{7 / 2} \\ {S}_{9 / 2} \\ … \\ {S}_{n / 2}\end{matrix} ] .$$

7. The system according to claim 6, wherein the processor determines the relative dip angle and the rotation using an expression of measured MTF components as
$$[ \begin{matrix}{R}_{xx} \\ {R}_{xy} \\ {R}_{xz} \\ {R}_{yx} \\ {R}_{yy} \\ {R}_{yz} \\ {R}_{zx} \\ {R}_{zy} \\ {R}_{zz}\end{matrix} ] = [ \begin{matrix}{cos}^{2} ϕ \cdot {cos}^{2} θ + {sin}^{2} ϕ & {cos}^{2} ϕ \cdot {sin}^{2} θ \\ cos ϕ \cdot sin ϕ \cdot {sin}^{2} θ & - cos ϕ \cdot sin ϕ \cdot {sin}^{2} θ \\ cos ϕ \cdot cos θ \cdot sin θ & - cos ϕ \cdot cos θ \cdot sin θ \\ cos ϕ \cdot sin ϕ \cdot {sin}^{2} θ & - cos ϕ \cdot sin ϕ \cdot {sin}^{2} θ \\ {sin}^{2} ϕ \cdot {cos}^{2} θ + {cos}^{2} ϕ & {sin}^{2} ϕ \cdot {sin}^{2} θ \\ - sin ϕ \cdot cos θ \cdot sin θ & sin ϕ \cdot cos θ \cdot sin θ \\ cos ϕ \cdot cos θ \cdot sin θ & - cos ϕ \cdot cos θ \cdot sin θ \\ - sin ϕ \cdot cos θ \cdot sin θ & sin ϕ \cdot cos θ \cdot sin θ \\ {sin}^{2} θ & {cos}^{2} θ\end{matrix} ] \cdot [ \begin{matrix}{R}_{xx}^{p} \\ {R}_{zz}^{p}\end{matrix} ] ,$$
where x denotes the x axis, y denotes the y axis, and z denotes the z axis, Rₓₓ^{p}, R_{zz}^{p} are principal components, an MTF response S_{5/2} among the MTF responses is denoted as R, θ is the relative dip angle, and φ is the rotation.

8. The system according to claim 1, wherein the processor is configured to estimate the dip angle and the azimuth angle of the formation based additionally on borehole deviation and azimuth.

9. A method of determining a dip angle and an azimuth angle of a formation, the method comprising:
disposing a transmitter in a borehole;
the transmitter changing a transmitted current to induce a current in an earth formation;
disposing a receiver in the borehole spaced apart from the transmitter;
the receiver receiving transient electromagnetic signals;
processing the transient electromagnetic signals to extract multi-time focusing (MTF) responses;
determining a relative dip angle and a rotation of a tool comprising the transmitter and the receiver based on the multi-time focusing responses; and
estimating the dip angle and the azimuth angle of the formation based on the relative dip angle and the rotation of the tool.

10. The method according to claim 9, further comprising measuring borehole deviation and azimuth.

11. The method according to claim 10, wherein the estimating the dip angle and the azimuth angle of the formation is based additionally on the borehole deviation and azimuth.

12. The method according to claim 9, wherein the disposing the transmitter includes disposing arrangement tri-axial transmitter, and the disposing the receiver includes disposing a tri-axial receiver.

13. The method according to claim 12, wherein three axes of the tri-axial transmitter are mutually orthogonal.

14. The method according to claim 13, wherein the receiving the transient electromagnetic signals includes receiving at least four components: XX, YY, ZZ, and ZX or XZ.

15. The method according to claim 9, wherein the extracting the MTF responses (S) is based on expanding voltage (V) into a series at the late times (t) which are later portions of a receiving time window for the transient electromagnetic signals:
V=S_{5/2}·t^{-5/2}+S_{7/2}·t^{-7/2}+S_{9/2}·t^{-9/2}+S_{11/2}·t^{-11/2}+ . . . .

16. The method according to claim 15, further comprising computing expansion coefficient {tilde over (\vec{S} corresponding with the MTF responses using voltage measurements, \vec{V}, for several known late times and the MTF responses according to a linear system:
$$[ \begin{matrix}{V}_{1} \\ {V}_{2} \\ {V}_{3} \\ {V}_{4} \\ … \\ {V}_{m - 1} \\ {V}_{m}\end{matrix} ] = [ \begin{matrix}{t}_{1}^{- 5 / 2} & {t}_{1}^{- 7 / 2} & {t}_{1}^{- 9 / 2} & … & {t}_{1}^{- n / 2} \\ {t}_{2}^{- 5 / 2} & {t}_{2}^{- 7 / 2} & {t}_{2}^{- 9 / 2} & … & {t}_{2}^{- 5 / 2} \\ {t}_{3}^{- 5 / 2} & {t}_{3}^{- 7 / 2} & {t}_{3}^{- 9 / 2} & … & {t}_{3}^{- n / 2} \\ {t}_{4}^{- 5 / 2} & {t}_{4}^{- 7 / 2} & {t}_{4}^{- 9 / 2} & … & {t}_{4}^{- n / 2} \\ … & … & … & … & … \\ {t}_{m - 1}^{- 5 / 2} & {t}_{m - 1}^{- 7 / 2} & {t}_{m - 1}^{- 9 / 2} & … & {t}_{m - 1}^{- n / 2} \\ {t}_{m}^{- 5 / 2} & {t}_{m}^{- 7 / 2} & {t}_{m}^{- 9 / 2} & … & {t}_{m}^{- 5 / 2}\end{matrix} ] \cdot [ \begin{matrix}{S}_{5 / 2} \\ {S}_{7 / 2} \\ {S}_{9 / 2} \\ … \\ {S}_{n / 2}\end{matrix} ] ,$$
wherein the linear system in matrix form is given by \vec{V}={tilde over (\hat{T}·{tilde over (\vec{S}.

17. The method according to claim 16, further comprising multiplying the linear system by the normalization matrix \hat{N} to yield \vec{V}={hacek over (\hat{T}·{hacek over (\vec{S}, where
$$\hat{N} = [ \begin{matrix}{t}_{1}^{5 / 2} & 0 & 0 & … & 0 \\ 0 & {t}_{1}^{/ 2} & 0 & … & 0 \\ 0 & 0 & {t}_{1}^{9 / 2} & … & 0 \\ … & … & … & … & … \\ 0 & 0 & 0 & … & {t}_{1}^{n / 2}\end{matrix} ] .$$

18. The system according to claim 17, further comprising obtaining {hacek over (\hat{T} based on exponentially growing time values, where p=tᵢ/tᵢ₋₁, as:
$$\hat{\tilde{T}} = \hat{\tilde{T}} \cdot \hat{N} = [ \begin{matrix}1 & 1 & 1 & … & 1 \\ {p}^{- 5 / 2} & {p}^{- 7 / 2} & {p}^{- 9 / 2} & … & {p}^{- n / 2} \\ {( {p}^{2} )}^{- 5 / 2} & {( {p}^{2} )}^{- 7 / 2} & {( {p}^{2} )}^{- 9 / 2} & … & {( {p}^{2} )}^{- n / 2} \\ {( {p}^{3} )}^{- 5 / 2} & {( {p}^{3} )}^{- 7 / 2} & {( {p}^{3} )}^{- 9 / 2} & … & {( {p}^{3} )}^{- n / 2} \\ … & … & … & … & … \\ {( {p}^{m - 2} )}^{- 5 / 2} & {( {p}^{m - 2} )}^{7 / 2} & {( {p}^{m - 2} )}^{- 9 / 2} & … & {( {p}^{m - 2} )}^{- n / 2} \\ {( {p}^{m - 1} )}^{- 5 / 2} & {( {p}^{m - 1} )}^{- 7 / 2} & {( {p}^{m - 1} )}^{- 9 / 2} & … & {( {p}^{m - 1} )}^{- n / 2}\end{matrix} ] .$$

19. The method according to claim 18, further comprising obtaining
$$\vec{\breve{S}} = {\hat{N}}^{- 1} \cdot \vec{\tilde{S}} = [ \begin{matrix}{S}_{5 / 2} \cdot {t}^{- 5 / 2} \\ {S}_{7 / 2} \cdot {t}^{- 7 / 2} \\ {S}_{9 / 2} \cdot {t}^{- 9 / 2} \\ … \\ {S}_{n / 2} \cdot {t}^{- n / 2}\end{matrix} ] ,$$
where an MTF response S_{5/2} among the MTF responses is obtained as R and is given by S_{5/2}=\tilde{S}₁=\check{S}₁·t₁^{5/2}.

20. The method according to claim 19, wherein the determining the relative dip angle and the rotation is based on an expression of measured MTF components as
$$[ \begin{matrix}{R}_{xx} \\ {R}_{xy} \\ {R}_{xz} \\ {R}_{yx} \\ {R}_{yy} \\ {R}_{yz} \\ {R}_{zx} \\ {R}_{zy} \\ {R}_{zz}\end{matrix} ] = [ \begin{matrix}{cos}^{2} ϕ \cdot {cos}^{2} θ + {sin}^{2} ϕ & {cos}^{2} ϕ \cdot {sin}^{2} θ \\ cos ϕ \cdot sin ϕ \cdot {sin}^{2} θ & - cos ϕ \cdot sin ϕ \cdot {sin}^{2} θ \\ cos ϕ \cdot cos θ \cdot sin θ & - cos ϕ \cdot cos θ \cdot sin θ \\ cos ϕ \cdot sin ϕ \cdot {sin}^{2} θ & - cos ϕ \cdot sin ϕ \cdot {sin}^{2} θ \\ {sin}^{2} ϕ \cdot {cos}^{2} θ + {cos}^{2} ϕ & {sin}^{2} ϕ \cdot {sin}^{2} θ \\ - sin ϕ \cdot cos θ \cdot sin θ & sin ϕ \cdot cos θ \cdot sin θ \\ cos ϕ \cdot cos θ \cdot sin θ & - cos ϕ \cdot cos θ \cdot sin θ \\ - sin ϕ \cdot cos θ \cdot sin θ & sin ϕ \cdot cos θ \cdot sin θ \\ {sin}^{2} θ & {cos}^{2} θ\end{matrix} ] \cdot [ \begin{matrix}{R}_{xx}^{p} \\ {R}_{zz}^{p}\end{matrix} ] ,$$
where x denotes the x axis, y denotes the y axis, and z denotes the z axis, Rₓₓ^{p}, R_{zz}^{p} are principal components, θ is the relative dip angle, and φ is the rotation.
